(19) United States
(12) Patent Application Publication
(10) Pub. No.: US 2024/0152938 A1
(43) Pub. Date: May 9, 2024

(54) Mobile Application Data Collection and Reward Method and System

(71) Applicant: APP CATS LLC, Minneapolis, MN (US)

(72) Inventors: Daniel E. Fischer, Minneapolis, MN (US); Kristin Michelle Geer, Minneapolis, MN (US); Bradley Charles Geer, Minneapolis, MN (US)

(21) Appl. No.: 18/373,943

(22) Filed: Sep. 27, 2023

Related U.S. Application Data
(60) Provisional application No. 63/377,273, filed on Sep. 27, 2022.

(51) Int. Cl. G06Q 30/0201; G06Q 30/0207; H04L 9/00

(52) U.S. Cl. CPC G06Q 30/0201; G06Q 30/0207; H04L 9/50

(57) ABSTRACT

Disclosed herein are a system and method including a CrowdDATA™ plug-in running on the CrowdDATA™ network providing a solution for web and mobile app providers that directly compensates app users who voluntarily wish to provide verified, anonymized data and interact with advertiser or other commercial content—and stores that data by interacting with servers on the CrowdDATA™ Network where it can be accessed for a fee by commercial or other organizations.

### RELATED APPLICATIONS

The present patent application claims priority from U.S. Provisional Patent Application No. 63/337,273, filed Sep. 27, 2022, which is incorporated by reference in its entirety herein.

### BACKGROUND

Collecting aggregated consumer data for advertising, market demographic, and other commercial or academic purposes has become extremely difficult due to consumer privacy laws, including General Data Rights Protection Agency (GDPR) and California Consumer Privacy Act (CCPA). The curtailment of mobile application (app) usage tracking following the introduction by Apple of the iOS14.5 mobile operating system that allows users to “opt-out” of being tracked contributes to this difficulty. For example, iOS14.5 allows users to “opt out” of being tracked. In many cases, mobile phone app users would readily consent to providing some information in exchange for a reward. This is not the same as being tracked. Also, providers of mobile apps in many cases would be eager to have access to the information that consenting mobile users provide. Currently, there is no facility for enabling mobile app users and mobile app providers to consensually supply data via a central platform.

### BRIEF DESCRIPTION OF THE DRAWINGS

FIG. 1 is a diagram of Mobile Application Data Collection System according to an embodiment.

FIG. 2 is a diagram of a CrowdDATA network topology according to an embodiment.

FIG. 3 is a diagram of a CrowdDATA enterprise edition network topology according to an embodiment.

FIG. 4 is a flow chart of a CrowdDATA reward process according to an embodiment.

FIG. 5 is a flow chart of CrowdDATA onboarding according to an embodiment.

FIGS. 6A and 6B are screen shots of mobile applications illustrating the gamification of the question and answer process according to an embodiment.

FIGS. 7A and 7B are screen shots of a mobile application reward store via CrowdDATA integration according to an embodiment.

FIGS. 8A and 8B are screen shots of a mobile application engagement leader board via CrowdDATA integration according to an embodiment.

### DETAILED DESCRIPTION

Disclosed herein are a method and system for mobile application data collection and reward. Providers of mobile applications (apps) utilize a plug-in that facilitates receiving data from app users and rewarding app users for their data. The method and system avoid user data blocking that might exist on some mobile platforms, as well various privacy laws such as GDPR, CCPA, etc., without doing anything illegal.

A CrowdDATA™ plug-in running on the CrowdDATA™ network provides a solution for web and mobile app providers that directly compensates app users who voluntarily wish to provide verified, anonymized data and interact with advertiser or other commercial content—and stores that data by interacting with servers on the CrowdDATA™ Network where it can be accessed for a fee by commercial or other organizations.

The plug-in solution facilitates data gathering and rewarding app users for their data. In an embodiment users redeem earned tokens for rewards with the app provider in a closed ecosystem. App providers are also rewarded with tokens for hosting question, data royalties, and/or providing users with services and products. Due to financial security regulations there may be separate reward (user) tokens and data (app provider) tokens.

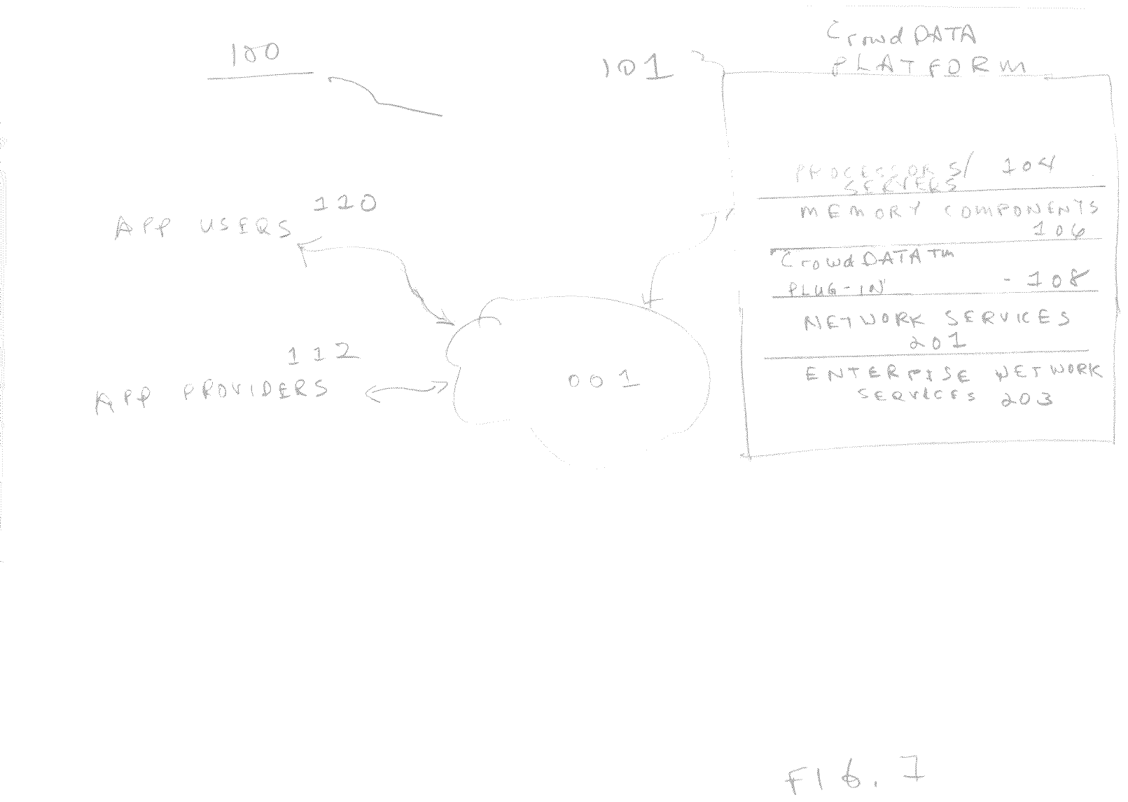

FIG. 1 is a diagram of Mobile Application Data Collection System 100 according to an embodiment. A platform 101 for performing the methods described herein is also referred to herein as the CrowdDATA™ platform, or “the platform”. Platform 101 includes multiple processor/servers 104, and multiple memory components 106. It is understood that the computing hardware and software associated with platform 101 may be distributed physically and virtually as is known in the art.

CrowdDATA™ plug-in 108 is a plug-in that can be integrated into mobile apps, as well as websites. Plug-in 108 interfaces with servers 104 that deploy data collected from app users to a CrowdDATA™ network that encompasses network services 201 and enterprise network services 203. Network services 201 and enterprise network services 203 are also referred to herein as the CrowdDATA™ network, or “the network”.

Plug-in 108 allows organizations to perform data queries across all previously collected CrowdDATA™ on the network, and to engage with those app users that fit their search criteria, either through advertisement, other forms of content, or smaller focus groups using a multi-directional CrowdLIVE™ streaming feature (not specifically described herein).

App users 110 and app providers 112 communication with the platform 101 via the internet 001 or any other facility to remotely communicate electronically between devices capable of such communication.

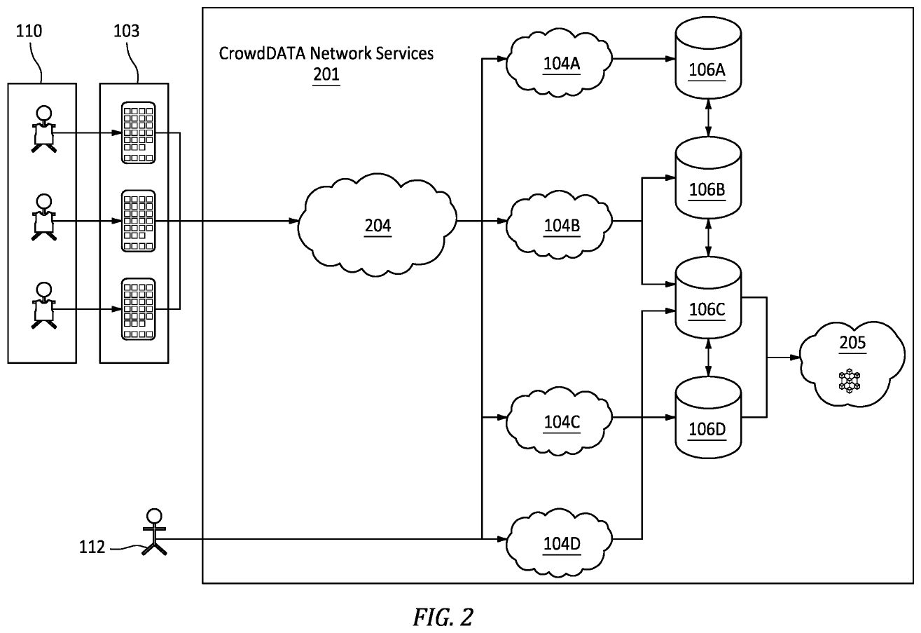

FIG. 2 is a diagram of a CrowdDATA™ network topology according to an embodiment.

CrowdDATA™ network services 201 include Plug-In 204 which interacts with mobile phones 103 of users 110. CrowdDATA™ network services also include various servers 104, including authentication server 104A, question and response server 104B, reward server 104C, and data market server 104D.

As shown in the diagram, the various servers 104 interact with various CrowdDATA™ 106 databases, including user authentication database 106A, question database 106B, response database 106C, and reward database 106D.

App provider 112 interacts with data market server 104D.

Databases 106C and 106D also communicate with blockchain reward token service 205.

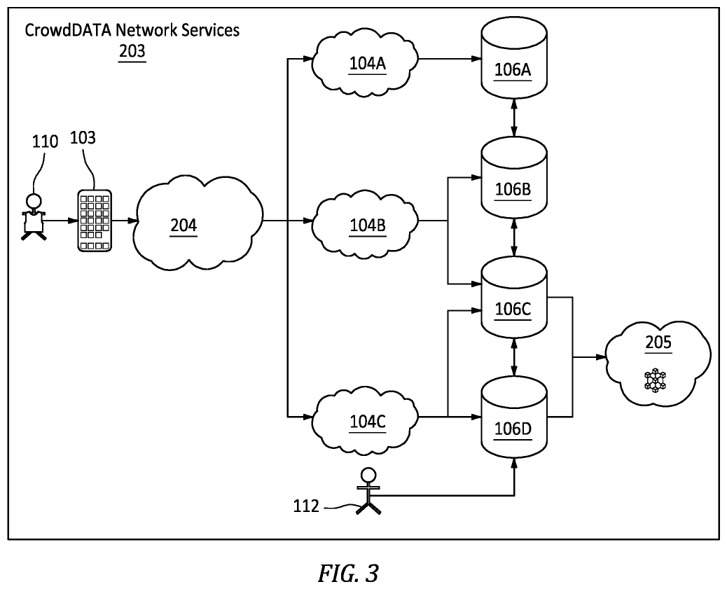

FIG. 3 is a diagram of a CrowdDATA™ enterprise edition network topology according to an embodiment. CrowdDATA™ enterprise network services 203 interacts with app users 110. A user 110 accesses the network services 203 via a mobile device 103, although it is understood that access can also be accomplished via a web site. Plug-in 204 is the interface between the user 110 and the user's device or other means of accessing the network services 203 though the platform 101.

In this enterprise case, the app provider 112 communicates with the reward database 106D within the network services 203. The plug-in 204 allows the user 110 to access the question and response server 104B as in FIG. 2. However, in this case, the app provider has more direct access to the reward data base 106D.

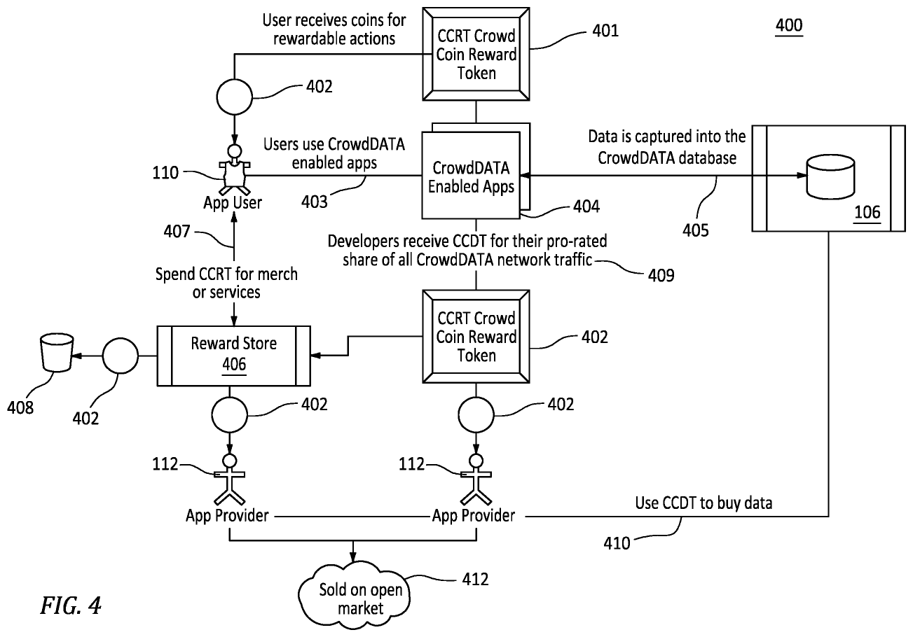

FIG. 4 is a flow chart of a CrowdDATA™ reward process 400 according to an embodiment. A user 110 can access (403) CrowdDATA™ enabled apps 404. From there user 110 can earn rewards 401, which include Crowd Coin Reward™ tokens 402. In the same transaction, data is captured 405 from the interaction and stored in the CrowdData™ database 106.

The user 110 can spend 407 the CCRT 402 (CrowdCoin™ reward token (hereinafter “token 402”) for merchandise or services at the rewards store 406. If not converted, tokens 402 can be stored in storage 408.

Developers receive a pro-rated share of all network traffic (see 409) in tokens 402.

App providers 112 also receive tokens 402 and generate tokens 402. App providers may participate in selling or buying tokens 402 on the open market 412. App providers 112 and also use tokens 402 to buy data (see 410).

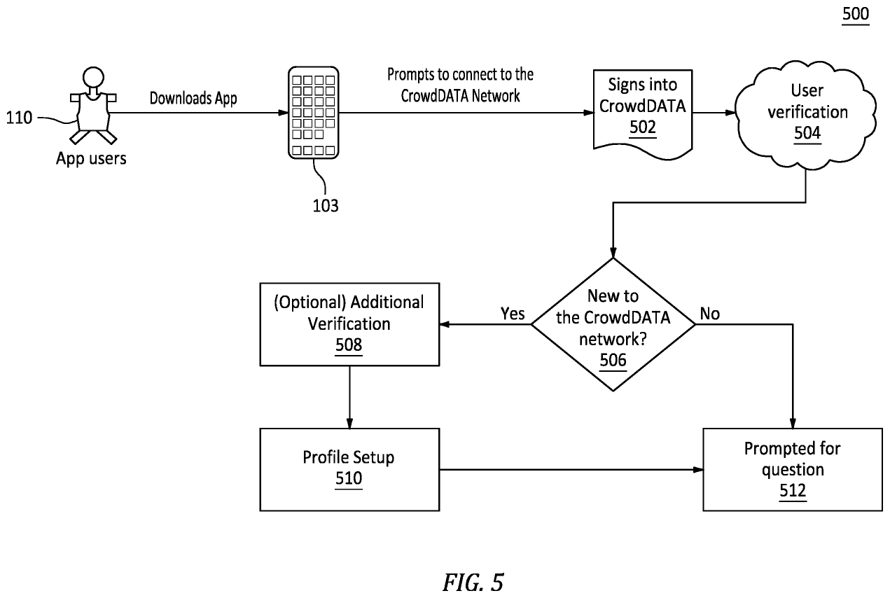

FIG. 5 is a flow chart 500 of CrowdDATA™ onboarding according to an embodiment. A user 110 downloads an app to a mobile phone 103 and is prompted to connect to the CrowdDATA™ network. The user then signs in (502) and undergoes user verification $04. At 506 it is determined whether the user is new to the network. If the user is not new to the network, the user is prompted for a question (512).

If the user is new to the network, the user is asks for additional verification (508) and prompted to set up a profile (510). After the profile is setup, the user can be prompted for a question (512).

Questions are served to users based on a variety of factors, including but not limited to:
app usage frequency;
app dictated question break;
app provider preference;
question priority;
question time sensitivity;
question integrity; and
user response rate.

In terms of question categories, question range from demographic to behavioral. For example:
Base level Data
   gender, location, age, education, income, etc.;
Participation Data
   event attendance across sports and entertainment
   hobby activities;
Consumption Data
   brand preferences
   food and beverage preferences;
Entertainment Data
   Team affiliation
   viewing habits
   wagering history;
App Provider Directed Questions; and

Other specific Surveys,

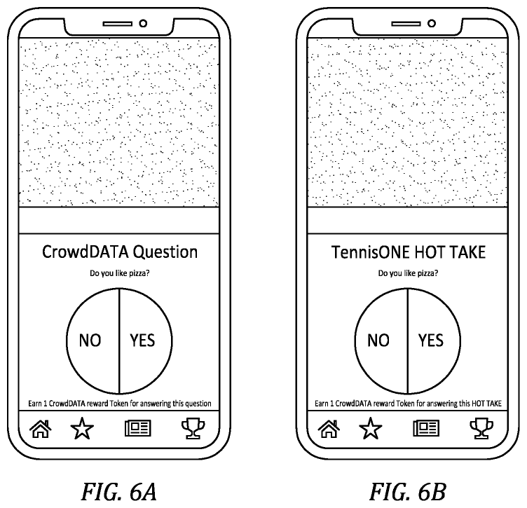

FIGS. 6A and 6B are screen shots of mobile applications illustrating the gamification of the question and answer process according to an embodiment. FIG. 6A shows a mobile phone screen with a CrowdDATA™ question—“do you like pizza?”. As shown the user can cam a token for answering the question. FIG. 6B illustrates a particular branded mobile app (in this case TennisONE. The question is posed as a TennisONE HOT TAKE. Again, the user can earn a token for answering the question. The objective is to keep questions simple and direct, and a non-traditional question interface is provided to prevent the user from feeling that answering is a chore. As shown, app branding is allowed for while still indicating CrowdDATA™ reward token payouts.

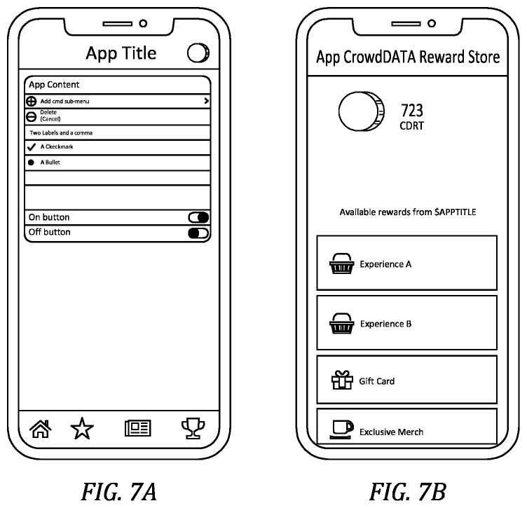

FIGS. 7A and 7B are screen shots of a mobile application reward store via CrowdDATA™ integration according to an embodiment. From the screen in FIG. 7A, the user can tap on the token icon to be taken to the screen in FIG. 7B where tokens can be redeemed. App providers can increase token income by providing app users with services, experiences, or physical products. In an embodiment, the app provider payout is based on the amount of CrowdDATA™ reward tokens consumed and the lifetime value of the user as well as network conditions.

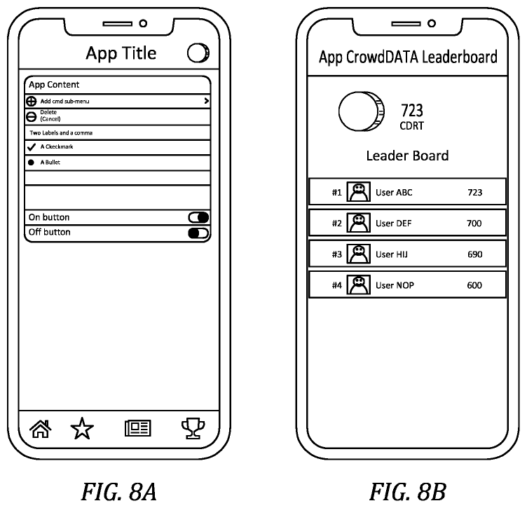

FIGS. 8A and 8B are screen shots of a mobile application engagement leader board via CrowdDATA integration according to an embodiment. App providers opting not to provide a reward store experience have a drop-in engagement leaderboard serving as the CrowdDATA™ homepage in their app. In Figure &A, which shows a screen of the app (which is not titled, but generically labeled App Title), a user can click on the token icon to bring up the screen in FIG. 8B, which shows a list of users and how many tokens they have accumulated.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to conduct a goal-directed semantic search. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which will be set forth in the forthcoming claims.

What is claimed is:

1. A system for interactive event viewing comprising:
a platform including multiple processors, servers, and memory components;
a plug-in software component that communicates with multiple application providers and multiple application users;
network services supported by the platform that include network services and enterprise network services, wherein the platform enables interaction between application users associated with the application providers and the platform, and wherein the application users and the application providers can access rewards through interacting with the platform.

2. The system of claim 1, further comprising multiple databases that store and make available data received from both the application providers and the application users.

3. The system of claim 1, further comprising a blockchain reward token service.

4. A method for rewarding voluntary data collection, the method comprising:
providing a plug-in to an application provider, wherein the plug-in enables the application provider to collect data from application users and to offer rewards to the application users; and
maintaining multiple databases that facilitate the process of collecting data form the application users and offering rewards to the application users.

5. The method of claim 4, further comprising facilitating a reward process including awarding tokens to application users and to application providers.

6. The method of claim 4, wherein the application provider may access a reward store maintained by the provider of the plug-in.

7. The method of claim 6, wherein the application providers are compensated based on their respective share of tokens generated over a period of time.

8. The method of claim 4, further comprising capturing data from applications that are provided by the application provider, and storing the captured data in a database.

9. The method of claim 8, further comprising allowing application providers access to the data in the database in exchange for a fee, wherein the fee can include tokens.
